(19) United States
(12) Patent Application Publication
(10) Pub. No.: US 2025/0246866 A1
(43) Pub. Date: Jul. 31, 2025

(54) Optical devices comprising a micro-resonator frequency comb

(71) Applicants: Israel REBOLLEDO SALGADO, Göteborg (SE); Iloomina AB, Partille (SE)

(72) Inventors: Victor TORRES COMPANY, Göteborg (SE); Israel REBOLLEDO SALGADO, Göteborg (SE); Óskar Bjarki HELGASON, Partille (SE)

(21) Appl. No.: 18/422,063

(22) Filed: Jan. 25, 2024

(51) Int. Cl. H01S 3/091; H01S 3/13; H01S 3/131

(52) U.S. Cl. CPC H01S 3/0912; H01S 3/1305; H01S 3/1312

(57) ABSTRACT

The disclosure relates to optical devices comprises a micro-resonator frequency comb comprising a main optical resonator cavity made of a first nonlinear resonator medium, and an auxiliary optical resonator cavity made of a second resonator medium coupled with the main optical resonator cavity, wherein the main optical resonator cavity or the auxiliary optical resonator cavity is configured to receive a continuous-wave laser light from a pump laser being optically coupled therewith.

### TECHNICAL FIELD

The disclosure relates to optical devices comprising a micro-resonator frequency comb (microcomb) comprising a main optical resonator cavity made of a first nonlinear resonator medium, and an auxiliary optical resonator cavity made of a second resonator medium coupled with the main optical resonator cavity, wherein the main optical resonator cavity or the auxiliary optical resonator cavity is configured to receive a continuous-wave laser light from a pump laser being optically coupled therewith.

### BACKGROUND ART

Dissipative Kerr solitons (DKSs) in micro-resonators have shown to possess a significant potential for diverse applications, including optical communications, metrology, and sensing, while maintaining a small form factor. These applications are enabled through a suite of advantageous features, encompassing a broad optical bandwidth, high repetition rates, and minimal power consumption. DKS microcombs can be generated in microcavities pumped with continuous wave lasers, wherein a delicate equilibrium is achieved through the interplay of the Kerr nonlinear shift with the cavity dispersion, and parametric gain effectively compensating for the cavity losses. Operating in the soliton regime leads to the emergence of phase-locked evenly space lines, where the pump laser must be far-red detuned with respect to the pump resonance. These evenly spaced lines constitute the micro-resonator frequency comb (microcomb).

Further, the intrinsic large free spectral range (FSR) of microcombs (within the gigahertz regime) is still a drawback for applications such as molecular spectroscopy, in which the comb line spacing dictates the spectral sampling resolution. Overcoming spectral sparsity by scanning the comb modes across a full FSR is challenging for a DKS microcomb, since the soliton operation must be kept while the pump laser is continuously swept.

There is thus a need for improvements within this field.

### SUMMARY OF THE DISCLOSURE

A first aspect of the disclosure relates to an optical device comprising:
a micro-resonator frequency comb comprising a main optical resonator cavity made of a first nonlinear resonator medium, and an auxiliary optical resonator cavity made of a second resonator medium coupled with the main optical resonator cavity, wherein the main optical resonator cavity or the auxiliary optical resonator cavity is configured to receive a continuous-wave laser light from a pump laser being optically coupled therewith,
a feedback control loop connected to the output of the main optical resonator cavity, wherein the feedback control loop comprises a photo detector wherein a portion of the optical power of the micro-resonator frequency comb is passed through the photo detector to measure the optical power of the micro-resonator frequency comb,
a control circuit connected to the photo detector, wherein the optical power measured by the photo detector is used as an input parameter for the control circuit to generate a control signal, wherein the control signal is arranged to be provided to the pump laser or to the main optical resonator cavity, such that the optical power measured in the photodetector is stabilized at a desired value.

The first aspect of the disclosure may seek to improve the stabilization of a highly efficient micro-resonator frequency comb, which makes it possible to apply the optical device practically in many fields. Examples where the optical device can be applied are for instance optical communications and dual-comb spectroscopy applications. Specifically, the optical device can be used in wavelength division multiplexing, lidar, optical spectroscopy, optical clocks, sensing, and microwave frequency synthesis.

A technical benefit may include that micro-resonator frequency combs will achieve a level of stability that allows them to be applied practically.

The first aspect relates to the interplay between the optical power of the micro-resonator frequency comb with the effective detuning in a super-efficient DKS generated in a photonic molecule comprising a main optical resonator cavity made of a first nonlinear resonator medium, and an auxiliary optical resonator cavity made of a second resonator medium coupled with the main optical resonator cavity. A similar relationship has been observed in the comb detuning as previously reported in single cavities.

To assess the robustness of this dependence, a feedback control is implemented, being able to sustain a solitary soliton state for a 30-hour duration by employing the optical power as the set point. Through numerical simulations, the relation between comb detuning and the optical power in a coupled cavity has been verified and a scenario akin to that in a single cavity with a Kerr-shifted resonance was found. Furthermore, the effective detuning is characterized using a counter-propagation method where the optical power is used as a setpoint to vary the bandwidth of the frequency comb, resulting in a higher conversion efficiency.

Optionally in some examples, including in at least one preferred example, the feedback control loop further comprises a band-pass filter connected to the photo detector. A technical benefit may include that the spectrum being passed through to the photo detectors can be adjusted.

Optionally in some examples, including in at least one preferred example, if the control signal is provided to the pump laser, the power, frequency and/or polarization state of the pump laser is changed such that the signal power in the photodetector is stabilized at a desired value.

A technical benefit may include that the pump laser can be used in a variety of ways to stabilize the signal power in the photodetector at a desired value.

Optionally in some examples, including in at least one preferred example, if the control signal is provided to the main optical resonator cavity, the refractive index of the main optical is tuned thermally, pie-zo-electrically, electro-optically, by optical modulation or electrostriction.

A technical benefit may include that besides the pump laser, also the main optical resonator cavity can be used in a variety of ways to stabilize the signal power in the photodetector at a desired value.

Optionally in some examples, including in at least one preferred example, stabilization of the optical power measured in the photodetector further stabilizes the repetition rate and the detuning of the pump laser without needing to measure them.

A technical benefit may include that the optical device will provide not only a stable signal power but also a stabilization of the repetition rate and the detuning of the pump laser without needing to measure them which has previously been necessary.

Optionally in some examples, including in at least one preferred example, the control circuit comprises one or more of a field-programmable gate array (FPGA), an application-specific integrated circuit (ASIC) or an analogue circuit comprising one or more resistors and one or more capacitors.

A technical benefit may include that the control circuit can be arranged in many different ways. The aim of the control circuit is to function as an analogue or digital regulator (PI, PD or PID regulator).

Optionally in some examples, including in at least one preferred example, the band-pass filter is tunable.

A technical benefit may include that this allows for an effective selection of the portion of the optical power of the micro-resonator frequency comb that is to be re-injected into the main optical resonator cavity.

Optionally in some examples, including in at least one preferred example, the portion of the optical power of the micro-resonator frequency comb passed through the photo detector to measure the optical power of the micro-resonator frequency comb is approximately 10%.

A technical benefit may include that approximately 10% is a large enough portion to allow a strong feedback signal without sacrificing too much of the final output power of the microcomb. This leaves approximately 90% of the power to be used in the application itself. In general, depending on power needed by the application and characteristics of the optical device, between 1% and 99% of the power can be passed through the photo detector to measure the optical power of the micro-resonator frequency comb.

Optionally in some examples, including in at least one preferred example, the main and auxiliary resonator cavities are made of lithium niobate, tantalum pentoxide, aluminium oxide, silicon nitride, silica, silicon, silicon oxynitride, silicon-rich silicon nitride, nitride-rich silicon nitride, aluminium nitride, diamond, aluminium gallium arsenide, gallium nitride or gallium phosphide.

A technical benefit may include that the main and auxiliary resonator cavities can be made of a variety of materials that allows for fine tuning of the characteristics of the main and auxiliary resonator cavities.

Optionally in some examples, including in at least one preferred example, the first nonlinear resonator medium is a second or third order non-linear medium. A technical benefit may include that such non-linearities are readily available in the material platforms described above.

Optionally in some examples, including in at least one preferred example, the free spectral range (FSR) of the main cavity and auxiliary cavity corresponds to approximately between 10-1000 GHz. A technical benefit may include that cavities with such FSRs values can be fabricated in most material platforms without low intrinsic-losses. It is possible to have lower and higher FSR at the cost of increased intrinsic losses per roundtrip.

Optionally in some examples, including in at least one preferred example, the main optical resonator and auxiliary optical resonator are designed with normal or anomalous dispersion. A technical benefit may include the fact that normal and anomalous dispersion can be achieved in many material platforms via rectangular waveguide designs

A second aspect of the disclosure relates to an optical device comprising:
a micro-resonator frequency comb comprising a main optical resonator cavity made of a first nonlinear resonator medium and an auxiliary optical resonator cavity made of a second nonlinear resonator medium coupled with the main optical resonator cavity, wherein the main optical resonator cavity or the auxiliary optical resonator cavity is configured to receive a continuous-wave laser light from a tunable pump laser being optically coupled therewith,
a feedback control loop connected to the output of the main optical resonator cavity, wherein the feedback control loop comprises a first photo detector and a second photo detector, wherein a portion of the optical power of the micro-resonator frequency comb is passed through each respective photo detectors to measure the optical power of the micro-resonator frequency comb,
a control circuit connected to the first and second photo detectors, wherein the optical power measured by each photo detector is used as input parameters for the control circuit to generate a first correction signal and a second correction signal, wherein the first and second correction signals are arranged to be provided to two of the pump laser, the main optical resonator cavity and the auxiliary optical resonator cavity, thereby allowing tuning of the centre frequency of the micro-resonator frequency comb by shifting the pump laser frequency if the first and second correction signals are provided to the main and auxiliary optical resonators, or, if the first and second correction signals are provided to the pump laser and one of the main optical resonator cavity and the auxiliary optical resonator cavity, tune the refractive index of the cavity not provided with a correction signal.

The second aspect of the disclosure may seek to improve the tuning of centre frequency of the comb.

A technical benefit may include that an optical device according to the second aspect is useful for optical spectroscopy to be able to fill gaps between comb lines. The optical device of the second aspect can also be used in wavelength division multiplexing, lidar, optical clocks, sensing, and microwave frequency synthesis.

Optionally in some examples, including in at least one preferred example, the feedback control loop comprises a first band-pass filter connected to the first photo detector and/or a second band-pass filter connected to the second photo detector. A technical benefit may include that the spectrum being passed through to the photo detectors can be adjusted.

Optionally in some examples, including in at least one preferred example, the refractive index of the main optical resonator cavity or the auxiliary optical resonator cavity are tuned thermally, piezo-electrically, electro-optically, by optical modulation or electrostriction.

A technical benefit may include that the method of tuning the refractive index can be adapted to suit different applications.

Optionally in some examples, including in at least one preferred example, the control circuit further comprises a voltage source providing a first voltage and a second voltage that are summed with the respective first and second correction signals generated by the control circuit.

A technical benefit may include that this improves the accuracy of the tuning.

Optionally in some examples, including in at least one preferred example, the control circuit comprises one or more of a field-programmable gate array (FPGA), an application-specific integrated circuit (ASIC) or an analogue circuit comprising one or more resistors and one or more capacitors.

A technical benefit may include that the control circuit can be arranged in many different ways. The aim of the control circuit is to function as an analogue or digital regulator (PI, PD or PID regulator).

Optionally in some examples, including in at least one preferred example, each band-pass filter is tunable.

A technical benefit may include that this allows for an effective selection of the portion of the optical power of the micro-resonator frequency comb that is to be re-injected into the main optical resonator cavity.

Optionally in some examples, including in at least one preferred example, the portion of the optical power of the micro-resonator frequency comb is approximately 10%.

A technical benefit may include that approximately 10% is a large enough portion to allow a strong feedback signal without sacrificing too much of the final output power of the microcomb. This leaves approximately 90% of the power to be used in the application itself. In general, depending on power needed by the application and characteristics of the optical device, between 1% and 99% of the power can be passed through the photo detectors to measure the optical power of the micro-resonator frequency comb.

Optionally in some examples, including in at least one preferred example, the main and auxiliary resonator cavities are made of lithium niobate, tantalum pentoxide, aluminium ox-ide, silicon nitride, silica, silicon, silicon oxynitride, silicon-rich silicon nitride, nitride-rich silicon nitride, aluminium nitride, diamond, aluminium gallium arsenide, gallium nitride or gallium phosphide.

A technical benefit may include that the main and auxiliary resonator cavities can be made of a variety of materials that allows for fine tuning of the characteristics of the main and auxiliary resonator cavities.

Optionally in some examples, including in at least one preferred example, the first nonlinear resonator medium is a second or third order non-linear medium. A technical benefit may include that such non-linearities are readily available in the material platforms described above.

Optionally in some examples, including in at least one preferred example, the free spectral range (FSR) of the main cavity and auxiliary cavity corresponds to approximately between 10-1000 GHz. It is possible to have lower and higher FSR at the cost of increased intrinsic losses per roundtrip. A technical benefit may include that cavities with such FSRs values can be fabricated in most material platforms without low intrinsic-losses.

Optionally in some examples, including in at least one preferred example, the main optical resonator and auxiliary optical resonator are designed with normal or anomalous dispersion. The technical benefit may include the fact that normal and anomalous dispersion can be achieved in many material platforms via rectangular waveguide designs

### BRIEF DESCRIPTION OF THE DRAWINGS

FIG. 1 schematically show an optical device according to a first aspect of the disclosure,

FIG. 2 schematically show a graph of the optical power measured using a photo-detector and a band-pass filter,

FIGS. 3a and 3b schematically shows long-term stabilization of the micro-resonator frequency comb,

FIG. 4 schematically show an optical device according to a second aspect of the disclosure.

### DETAILED DESCRIPTION

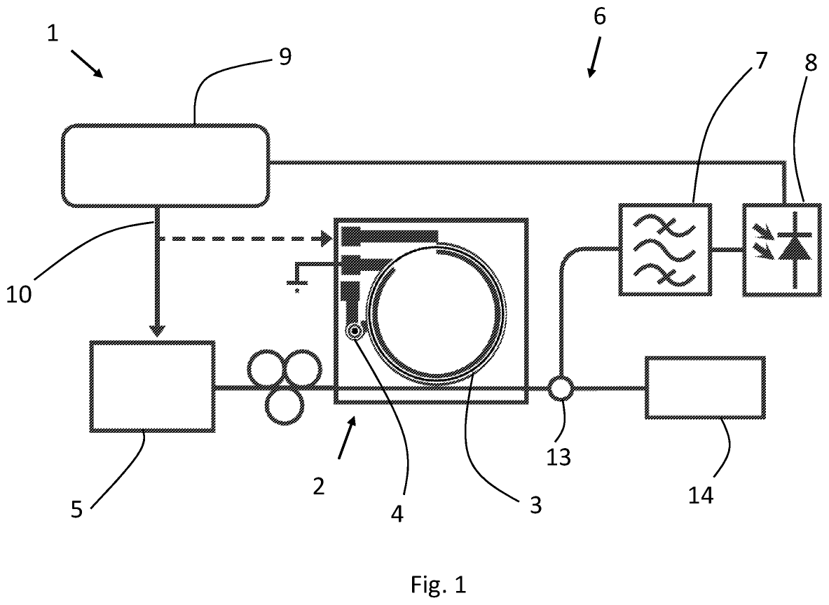

FIG. 1 schematically show an optical device 1 according to a first aspect of the disclosure. The optical device 1 comprises a micro-resonator frequency comb 2 comprising a main optical resonator cavity 3 made of a first nonlinear resonator medium, and an auxiliary optical resonator cavity 4 made of a second resonator medium coupled with the main optical resonator cavity 3. The main optical resonator cavity 3 or the auxiliary optical resonator cavity 4 is configured to receive a continuous-wave laser light from a pump laser 5 being optically coupled therewith. The optical device 1 further comprises a feedback control loop 6 connected to the output of the main optical resonator cavity 3. The feedback control loop 6 comprises an optional band-pass filter 7 connected to a photo detector 8, wherein a portion of the optical power of the micro-resonator frequency comb 2 is passed through the band-pass filter 7 to the photo detector 8 to measure the optical power of the micro-resonator frequency comb 2. For the passing of a portion of the power a power splitter 13 is used, taking one portion of the output power and feeding it to the feedback loop 6, while the rest of the power from the power splitter 13 constitutes the final output 14 of the optical device. The feedback control loop 6 further comprises a control circuit 9 connected to the photo detector 8. The optical power measured by the photo detector 8 is used as an input parameter for the control circuit 9 to generate a control signal 10, wherein the control signal 10 is arranged to be provided to the pump laser 5 or to the main optical resonator cavity 3, such that the optical power measured in the photodetector 8 is stabilized at a desired value.

The optical connections of a commercial packaging solution of the optical device 1 consist of a fibre array followed by a spot-size converter that is edged coupled to a chip. The total throughput losses are 6.2 dB. The temperature of the chip is stabilized using a thermistor and a thermoelectric cooler integrated into the module. The packaging of the microring resonators allows for keeping a constant throughput power which is an important parameter for the microcomb generation and stabilization.

In one example, the optical device comprises a photonic molecule composed of two coupled cavities, main 3 and auxiliary 4, fabricated in a silicon nitride (Si₃N₄) platform using a subtractive method. The dimensions of the waveguides are 1800 nm×700 nm for both micro resonator cavities 3, 4. Microheaters are placed on top of the cavities. The temperature of the chip is stabilized using a thermistor and a thermoelectric cooler integrated into the module.

As an alternative to stabilizing by heating, stabilizing can also be done piezo-electrically, electro-optically, by optical modulation or by electrostriction.

The free spectral range (FSR) of the main cavity 3 and auxiliary cavity 4 corresponds to 99.73 GHz and 970 GHz. As a consequence of the mismatch of the FSR's, a Vernier effect occurs between the longitudinal modes of the cavities 3, 4, causing a strong avoided mode crossing at a particular mode of the main cavity 3. This can be observed in the characterized dispersion of the main cavity 3, where a frequency-calibrated swept-wavelength interferometry method was used. The measured integrated dispersion of the fundamental mode has retrieved values of the fitting are D₁/2π=99.73 GHZ and D₂/2π=5.12 MHz. The converted β₂ is −91.4 ps²·km⁻¹ at 1550 nm. The measured mean intrinsic Q factor is Qᵢ=9.6 million and extrinsic Q factor Qₑ=2.6 million.

The main optical resonator cavity 3 or the auxiliary optical resonator cavity 4 can be pumped using an external-cavity diode laser (ECDL) 5 at 1563 nm with an on-chip power of 30 mW. During the initiation process the pump laser 5 is tuned from blue towards red. The auxiliary cavity resonance is then brought into close proximity to the main cavity, resulting in mode-splitting. This causes a further shift of the pump resonance towards the red. After a micro-resonator comb corresponding to a single DKS in the main cavity is generated, the optical power is reduced to 15 mW increasing the conversion efficiency. The final spectrum of the comb covers a 20-dB bandwidth of 75 nm with a conversion efficiency of around 36 percent. Such efficiency is defined as the ratio between the comb power (without pump) and the input power.

The optical power of the super-efficient microcomb is tapped off for monitoring and feedback-locking by acting on the laser or the refractive index of one or both of the main and auxiliary optical resonator cavities. Ten percent of the power is sent to the band-pass filter 7 and the photo-detector 8. The photo-detected optical power is then used as a setpoint at the input of the control circuit 9 of the feedback control loop 6. In the example of FIG. 1, the control circuit comprises a field-programmable gate array (FPGA) board where the optical power signal is processed and a correction signal 10 is generated through a proportional-integral-derivative (PID) control. Alternatives to the FPGA are an application-specific integrated circuit (ASIC) or an analogue circuit comprising one or more resistors and one or more capacitors.

Since the photonic molecule, i.e. the main and auxiliary cavities 3, 4, has integrated heaters, this system can be implemented with a correction signal applied to act either on the main cavity resonance or in a voltage-controlled piezo of the pump laser 5. The key aspect is the direct relation that exists between the optical power and detuning.

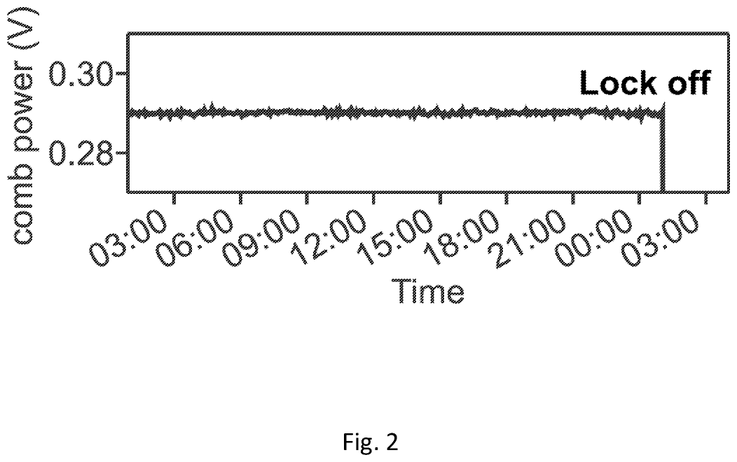

FIG. 2 schematically show a graph of the soliton power or optical power (converted into volts) measured using the photo-detector 8 and the band-pass filter (BPF) 7 as described in FIG. 1. The photo-detected current is converted to voltage and used as a setpoint to lock the microcomb using the control circuit 9.

The active locking method enabled by the optical device 1 of FIG. 1 stabilizes the optical power and enables long term operation while the lock is engaged. The comb power is also monitored using an oscilloscope as shown in FIG. 2, where the power remains constant until the control is terminated.

The microcomb spectrum can also be analysed using an optical spectrum analyser (OSA). The optical spectrum was recorded over the thirty hours the comb was running. It was observed that the power of the comb lines remained constant over the whole span.

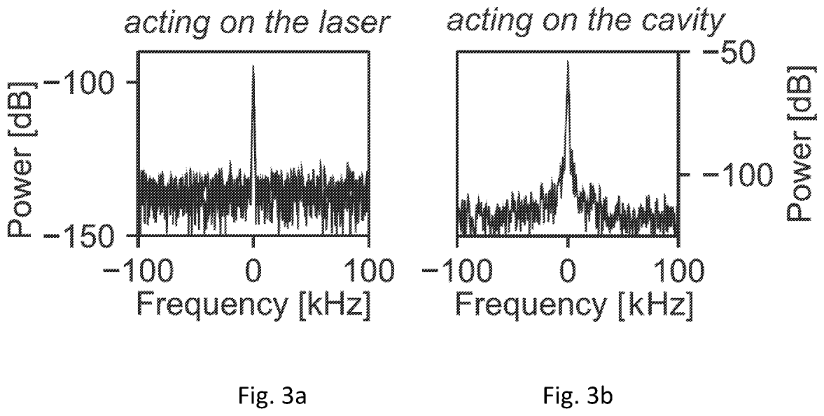

FIGS. 3a and 3b schematically shows long-term stabilization of the micro-resonator frequency comb repetition rate. Down-converted beat note of the repetition rate of the microcomb when the correction signal is fed back into the piezo control of the pump laser 5, as seen in FIG. 3a, and to the microheater of the main cavity 3, as seen in FIG. 3b.

Two experiments to test the robustness of this feedback control was performed. In the first, the feedback was acting on the pump laser frequency, and in the second, it was acting on the microheater of the main cavity 3.

The drift of the repetition rate (fᵣₑₚ) frequency was recorded while the microcomb was locked as shown in 3b. Simultaneously, the frequency of the pump laser was measured by heterodyne detection with a self-referenced frequency comb, and the beat note was recorded using an electrical spectrum analyser with a resolution bandwidth of 30 kHz. It is readily apparent that the repetition rate frequency follows the frequency of the pump laser, with standard deviations of σ_{f}_{ᵣₑₚ}=5 kHz and σ_{f}_{_{ceo}}=10 MHz, respectively. This effect is attributed to the coupling between the pulse rate and the third-order dispersion, which in turn, causes the soliton to experience a different velocity as its central frequency is changed.

A similar behaviour is encountered when the microcomb is locked using the cavity heater, where σ_{f}_{ᵣₑₚ} drifts in a linear manner following the change in frequency of σ_{f}_{_{ceo}}. In this case, the thermo-optic effect of the Si₃N₄ waveguide is used to correct the spectral position of the pumped resonance to maintain the soliton detuning. Since the pump frequency drift is free running, the beat note decreases in frequency until it leaves the measurement span, as the drift continues, the laser starts to beat with a neighbouring line of the frequency comb, which appears as an increase in the beat note frequency. The significant drift results from the ECDL pump's drift, arising from thermal cavity expansion triggered by variations in environmental conditions. These two cases show that the coupling between the soliton power and the relative cavity-pump detuning holds in a photonic molecule configuration where a super-efficient soliton is generated.

The first aspect of the invention is described in the paper “Active Feedback Stabilization of Super-efficient Microcombs” by I. Rebolledo-Salgado, Ó. B. Helgason, M. Girardi, M. Zelan, and V. Torres-Company, in Conference on Lasers and Electro-Optics/Europe (CLEO/Europe 2023) and European Quantum Electronics Conference (EQEC 2023). Technical Digest Series (Optica Publishing Group, 2023), paper ci_2_2. Available at doi.org/10.1109/CLEO/Europe-EQEC57999.2023.10232765. The paper is incorporated by reference in its entirety.

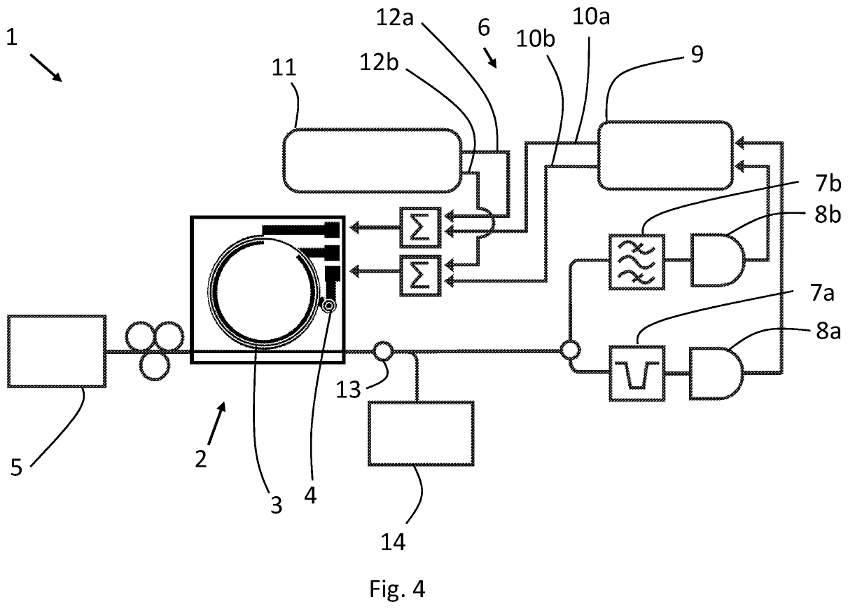

FIG. 4 schematically show an optical device 11 according to a second aspect of the disclosure. The optical device 11 is similar to the optical device 1 in FIG. 1, and the same reference number is used for the same components.

The optical device 11 comprises a micro-resonator frequency comb 2 comprising a main optical resonator cavity 3 made of a first nonlinear resonator medium and an auxiliary optical resonator cavity 4 made of a second nonlinear resonator medium coupled with the main optical resonator cavity 3. The main optical resonator cavity 3 or the auxiliary optical resonator cavity 4 is configured to receive a continuous-wave laser light from a tunable pump laser 5 being optically coupled therewith. A feedback control loop 6 is connected to the output of the main optical resonator cavity 3. The feedback control loop 6 comprises a first optional band-pass filter 7a connected to a first photo detector 8a and a second optional band-pass filter 7b connected to a second photo detector 8b, wherein a portion of the optical power of the micro-resonator frequency comb 2 is passed through each respective band-pass filter 7a, 7b to the respective photo detectors 8a, 8b to measure the optical power of the micro-resonator frequency comb 2. The feedback control loop 6 further comprises a control circuit 9 connected to the first and second photo detectors 8a, 8b, wherein the optical power measured by each photo detector 8a, 8b is used as input parameters for the control circuit 9 to generate a first correction signal 10a and a second correction signal 10b. The first and second correction signals 10a, 10b are arranged to be provided to two of the pump laser 5, the main optical resonator cavity 3 and the auxiliary optical resonator cavity 4, thereby allowing tuning of the centre frequency of the micro-resonator frequency comb 2 by shifting the pump laser frequency if the first and second correction signals 10a, 10b are provided to the main and auxiliary optical resonator cavities 3, 4, or, if the first and second correction signals 10a, 10b are provided to the pump laser 5 and one of the main optical resonator cavity 3 and the auxiliary optical resonator cavity 4, tune the refractive index of the cavity not provided with a correction signal. In the example of FIG. 4, the first correction signal 10a is provided to the main optical resonator cavity 3 and the second correction signal 10b is provided to the auxiliary optical resonator cavity 4. In this example, tuning of the centre frequency of the micro-resonator frequency comb 2 is thus made by shifting the pump laser frequency of the pump laser 5.

Thus, in the second aspect, the element which does not receive a correction signal out of the pump laser 5, the main optical resonator cavity 3 and the auxiliary optical resonator cavity 4 are used to tune the centre frequency of the micro-resonator frequency comb 2.

For the passing of a portion of the power, a power splitter 13 is used, taking one portion of the output power and feeding it to the feedback loop 6, while the rest of the power from the power splitter 13 constitutes the final output 14 of the optical device 1.

In one example, a photonic molecule composed of two coupled optical resonator cavities, a main optical resonator cavity 3 and an auxiliary optical resonator cavity 4, fabricated in a silicon nitride (Si₃N₄) platform using a subtractive method. The dimensions of the waveguides are 1800 nm×700 nm for both cavities 3, 4. Microheaters are placed on top of the cavities 3, 4. The temperature of the chip is stabilized using a thermistor and a thermoelectric cooler integrated into the module.

The refractive index of the main optical resonator cavity 3 or the auxiliary optical resonator cavity 4 can besides being tuned thermally alternatively be tuned piezo-electrically, electro-optically, by optical modulation or electrostriction

Over the last few years, dissipative Kerr solitons (DKS) in microresonators have boosted the development of chipscale frequency comb sources (microcombs) in a variety of applications, from coherent communications to ultrafast distance ranging. However, the intrinsic large free spectral range (FSR) of microcombs (within the gigahertz regime) is still a drawback for applications such as molecular spectroscopy, in which the comb line spacing dictates the spectral sampling resolution. Overcoming spectral sparsity by scanning the comb modes across a full FSR is challenging for a DKS microcomb, since the soliton operation must be kept while the pump laser is continuously swept. So far, it has been accomplished for a single microresonator by combining a feedback control loop with the thermal tuning of the cavity resonances by means of a microheater.

According to the second aspect, the use of two linearly coupled optical resonator cavities 3, 4 (i.e., a photonic molecule) has shown to generate a micro-resonator frequency comb 2 with high conversion efficiency and uniform power distribution. The second aspect of the disclosure addresses the challenge of scanning the soliton comb modes of a photonic molecule by thermal tuning. Specifically, a scheme to scan a bright soliton over 60 GHz by tuning simultaneously the pump laser 5 and the resonances of two coupled cavities 3, 4 has been implemented.

The second aspect of the invention is described in the paper “Thermal-Controlled Scanning of a Bright Soliton in a Photonic Molecule,” by I. Rebolledo-Salgado, V. Durán, Ó. B. Helgason, M. Girardi, M. Zelan, and V. Torres-Company, in Conference on Lasers and Electro-Optics/Europe (CLEO/Europe 2023) and European Quantum Electronics Conference (EQEC 2023). Technical Digest Series (Optica Publishing Group, 2023), paper ed_6_2. Available at doi.org/10.1109/CLEO/Europe-EQEC57999.2023.10231468. The paper is incorporated by reference in its entirety.

By simultaneously scanning the pump laser 5 and both resonances of the cavities 3, 4 the soliton state is maintained. This is shown in the above referenced paper of the second aspect where the optical spectrum power appears to be constant over the 60 GHz pump frequency shift.

The control circuit 9 may further comprise a voltage source 11 providing a first voltage 12a and a second voltage 12b that are summed with the respective first and second correction signals 10a, 10b generated by the control circuit 9.

In the example of FIG. 4, the tuning is performed using an arbitrary waveform generator (AWG) as a voltage source 11 or power supply and its generated voltages 12a, 12b are added with respective correction signals 10a, 10b generated by an FPGA board functioning as the control circuit 9. The optical power is used as a set point to keep a fixed detuning between the pump laser 5 and the main cavity resonance 3. An additional band-pass filter 7b can be used to generate an error signal to force the auxiliary cavity 4 to follow the pump frequency change. Photo-detected beat notes at the start and end of the tuning show that the comb remains coherent and stable over the scanning. A linear change in the repetition rate as a function of the wavelength that can be attributed to the third-order dispersion of the cavity was observed.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. Optical device comprising:
a micro-resonator frequency comb comprising a main optical resonator cavity made of a first nonlinear resonator medium, and an auxiliary optical resonator cavity made of a second resonator medium coupled with the main optical resonator cavity, wherein the main optical resonator cavity or the auxiliary optical resonator cavity is configured to receive a continuous-wave laser light from a pump laser being optically coupled therewith,
a feedback control loop connected to an output of the main optical resonator cavity, wherein the feedback control loop comprises a photo detector, wherein a portion of an optical power of the micro-resonator frequency comb is passed through the photo detector to measure the optical power of the micro-resonator frequency comb,
a control circuit connected to the photo detector, wherein the optical power measured by the photo detector is used as an input parameter for the control circuit to generate a control signal, wherein the control signal is arranged to be provided to the pump laser or to the main optical resonator cavity, such that the optical power measured in a photodetector is stabilized at a desired value.

2. Optical device according to claim 1, wherein the feedback control loop further comprises a band-pass filter connected to the photo detector.

3. Optical device according to claim 1, wherein if the control signal is provided to the pump laser, a power, frequency and/or polarization state of the pump laser is changed such that a signal power in the photo detector is stabilized at a desired value.

4. Optical device according to claim 1, wherein if the control signal is provided to the main optical resonator cavity, a refractive index of the main optical resonator cavity is tuned thermally, piezo-electrically, electro-optically, by optical modulation or electrostriction.

5. Optical device according to claim 1, wherein stabilization of the optical power measured in the photo detector further stabilizes a repetition rate and a detuning of the pump laser without needing to measure them.

6. Optical device according to claim 1, wherein the control circuit comprises one or more of a field-programmable gate array (FPGA), an application-specific integrated circuit (ASIC) or an analogue circuit comprising one or more resistors and one or more capacitors.

7. Optical device according to claim 1, wherein the main optical resonator cavity and auxiliary optical resonator cavity are designed with normal or anomalous dispersion.

8. Optical device according to claim 2, wherein the band-pass filter is tunable.

9. Optical device according to claim 1, wherein the first nonlinear resonator medium is a second or third order non-linear medium.

10. Optical device according to claim 1, wherein a free spectral range (FSR) of the main optical resonator cavity and auxiliary optical resonator cavity corresponds to approximately between 10-1000 GHz.

11. Optical device according to claim 1, wherein the portion of the optical power of the micro-resonator frequency comb is approximately 10%.

12. Optical device according to claim 1, wherein the main and auxiliary resonator cavities are made of lithium niobate, tantalum pentoxide, aluminium oxide, silicon nitride, silica, silicon, silicon oxynitride, silicon-rich silicon nitride, nitride-rich silicon nitride, aluminium nitride, diamond, aluminium gallium arsenide, gallium nitride or gallium phosphide.

13. Optical device comprising:
a micro-resonator frequency comb comprising a main optical resonator cavity made of a first nonlinear resonator medium and an auxiliary optical resonator cavity made of a second nonlinear resonator medium coupled with the main optical resonator cavity, wherein the main optical resonator cavity or the auxiliary optical resonator cavity is configured to receive a continuous-wave laser light from a tunable pump laser being optically coupled therewith,
a feedback control loop connected to an output of the main optical resonator cavity, wherein the feedback control loop comprises a first photo detector and a second photo detector, wherein a portion of an optical power of the micro-resonator frequency comb is passed through the respective photo detectors to measure the optical power of the micro-resonator frequency comb,
a control circuit connected to the first and second photo detectors, wherein the optical power measured by each photo detector is used as input parameters for the control circuit to generate a first correction signal and a second correction signal, wherein the first and second correction signals (are arranged to be provided to two of the pump laser, the main optical resonator cavity and the auxiliary optical resonator cavity, thereby allowing tuning of a centre frequency of the micro-resonator frequency comb by shifting a pump laser frequency if the first and second correction signals are provided to the main and auxiliary optical resonators, or, if the first and second correction signals are provided to the pump laser and one of the main optical resonator cavity and the auxiliary optical resonator cavity, tune a refractive index of the optical resonator cavity not provided with a correction signal.

14. Optical device according to claim 13, wherein the feedback control loop comprises a first band-pass filter connected to the first photo detector and/or a second band-pass filter connected to the second photo detector.

15. Optical device according to claim 13, wherein the refractive index of the main optical resonator cavity or the auxiliary optical resonator cavity are tuned thermally, piezo-electrically, electro-optically, by optical modulation or electrostriction.

16. Optical device according to claim 13, wherein the control circuit further comprises a voltage source providing a first voltage and a second voltage that are summed with the respective first and second correction signals generated by the control circuit.

17. Optical device according to claim 13, wherein the control circuit comprises one or more of a field-programmable gate array (FPGA), an application-specific integrated circuit (ASIC) or an analogue circuit comprising one or more resistors and one or more capacitors.

18. Optical device according to claim 13, wherein the main optical resonator cavity and auxiliary optical resonator cavity are designed with normal or anomalous dispersion.

19. Optical device according to claim 14, wherein each band-pass filter is tunable.

20. Optical device according to claim 13, wherein the first and second nonlinear resonator media are second or third order non-linear media.

21. Optical device according to claim 13, wherein a free spectral range (FSR) of the main optical resonator cavity and auxiliary optical resonator cavity corresponds to approximately 10 GHz-1000 GHz.

22. Optical device according to claim 13, wherein the portion of the optical power of the micro-resonator frequency comb is approximately 10%.

23. Optical device according to claim 13, wherein the main and auxiliary optical resonator cavities are made of lithium niobate, tantalum pentoxide, aluminium oxide, silicon nitride, silica, silicon, silicon oxynitride, silicon-rich silicon nitride, nitride-rich silicon nitride, aluminium nitride, diamond, aluminium gallium arsenide, gallium nitride or gallium phosphide.
